(19) United States
(12) Patent Application Publication
(10) Pub. No.: US 2007/0171667 A1
(43) Pub. Date: Jul. 26, 2007

(54) Vehicular lamp

(75) Inventors: Shigeyuki Watanabe, Shizuoka-shi (JP); Hironori Tsukamoto, Shizuoka-shi (JP); Masahiro Oda, Shizuoka-shi (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/649,526

(22) Filed: Jan. 4, 2007

(30) Foreign Application Priority Data
Jan. 26, 2006 (JP) 2006-017486

(51) Int. Cl. F21V 21/00

(52) U.S. Cl. 362/545; 362/544; 362/548; 362/549; 362/249

(57) ABSTRACT

A vehicular lamp including power supply connectors 20, attached to a bracket 10, and LED modules 30, attached detachably to the power supply connectors 20, respectively. The LED module includes an LED circuit board 31, an LED 32 mounted on the LED circuit board, and conduction portions 33 disposed on the LED circuit board and electrically connected to the LED. The power supply connector includes an accommodation portion 41, into which the LED circuit board of the LED module is inserted when the power supply connector is attached to the bracket, and a pair of contact terminals 50. When the LED circuit board of the LED module is inserted in the accommodation portion of the power supply connector, the contact terminals of the power supply connector contact the conduction portions of the LED module, thus making an electrical connection between the LED module and the power supply connector.

### BACKGROUND OF THE INVENTION

1. Field of the Invention

The present invention relates to a vehicular lamp and more particularly to a vehicular lamp with a light-emitting diode (referred to as an “LED” hereafter) used as its light source.

2. Description of the Related Art

A tungsten incandescent lamp, a halogen lamp, a discharge bulb, and so on are typically used as the light source of marker lamps for vehicles such as automobiles. Due the factors that high intensity LEDs have been developed and the manufacturing costs have been reduced, LEDs are more frequently used in vehicular lamps.

It is generally required that vehicular lamps illuminate over a comparatively wide range of area, and thus a particularly high degree of output is required for headlamps. Accordingly, a single lamp uses more than one LED, and it is typically common that one or more LED circuit boards, each having a plurality of LEDs thereof, are provided in a lamp chamber.

Incidentally, in conventional vehicular lamps that use LEDs as the light source and are structured as described above, the size and shape of the lamp differ depending upon the type of vehicle in which the lamp is installed. As a result, the required number of LEDs and their installation patterns are not uniform, and the size and shape of the LED circuit board and the number of LEDs mounted thereon are also different. As a result, a particular LED circuit board especially designed for a particular vehicle type is required, and this inevitably causes cost increase.

Moreover, when one of the LEDs breaks, the LED circuit board that includes the broken LED is removed, and then the broken LED is replaced, or the LED circuit board itself, on which a large number of LEDs are mounted, is replaced. Thus, the maintenance is labor-intensive and involves a great amount of cost.

### BRIEF SUMMARY OF THE INVENTION

In view of the above, the object of the present invention is to provide a vehicular lamp that facilitates the assembly and replacement of the light source of a vehicular lamp that uses an LED(s) as the light source.

The above object is accomplished by a unique structure of the present invention for a vehicular lamp that includes a plurality of power supply connectors attached to a lamp body, and a plurality of LED modules attached to the power supply connectors in a detachable manner; and in the present invention,

the LED module is comprised of an LED circuit board in a form of substantially flat plate, an LED provided on the LED carrying surface of the LED circuit board, and a pair of conduction portions provided on the LED circuit board and electrically connected to the LED;

the power supply connector is comprised of an attachment portion attached to the lamp body, an accomodation portion into which the LED circuit board of the LED module is inserted in a direction parallel to the LED carrying surface when the power supply connector is attached to the lamp body, and a pair of contact terminals; and

when the LED circuit board of the LED module is inserted into the accommodation portion of the power supply connector so that the LED module is attached to the power supply connector, the pair of contact terminals of said power supply connector is in contact with the pair of conduction portions of said LED module, respectively.

In this vehicular lamp of the present invention, the LED module is-attached to the power supply connector, and the LED of the LED module is connected to the contact terminals of the power supply connector simply by inserting the LED circuit board of the LED module into the accommodation portion of the plurality of power supply connectors attached to the lamp body.

In addition, in the vehicular lamp of the present invention, attaching of the LED module to the power supply connector and connecting of the LED of the LED module to the contact terminals of the power supply connector can be done simultaneously simply by inserting the LED circuit board of the LED module, which includes the conduction portions, into the accommodation portion of the power supply connector in a direction parallel to the LED carrying surface of the LED circuit board. In view of this structure, the LED module and the power supply connector can be standardized for universal use by way of simply providing a power supply connector which is for disposing the required number of LEDs at the required positions in the lamp. As a result, the LED module and power supply connector can be mass-produced, contributing to a cost reduction; and moreover, in case that one of the LEDs breaks, only the LED module that has the broken LED is replaced. Furthermore, as described above, the LED module can be attached to (and therefore removed from) the power supply connector extremely easily.

Furthermore, in the present invention, the contact terminals of the power supply connector come into engagement with the LED circuit board inserted in the accommodation portion in such a manner that the LED circuit board is prevented from falling out of the accommodation portion of the power supply connector. Accordingly, there is no need to provide the power supply connector with a separate means for preventing the LED circuit board from falling out, and this also contributes to a cost reduction.

Furthermore, in the present invention, when the LED module is attached to the power supply connector, the surface which is on the opposite side from the LED carrying surface of the LED circuit board contacts a part of the lamp body. Accordingly, by forming a part of the lamp body from a material that possesses good thermal conductivity, heat generated through illumination of the lamp can be discharged effectively.

### BRIEF DESCRIPTION OF THE SEVERAL VIEWS OF THE DRAWINGS

FIG. 1 shows a part of the lamp interior of a vehicular lamp according to the first embodiment of the present invention;

FIG. 2 shows the LED module, the power supply connector, and a part of the lamp body to which the power supply connector is attached in the first embodiment of the present invention;

FIG. 3 shows the power supply connector attached to the lamp body and the LED module which is to be attached to the power supply connector in the first embodiment of the present invention;

FIG. 4 shows, in cross-section, the LED module attached to the power supply connector in the first embodiment of the present invention;

FIG. 5 shows the LED module, the power supply connector, and a part of the lamp body to which the power supply connector is attached in the second embodiment of the present invention;

FIG. 6 shows the power supply connector attached to the lamp body and the LED module which is to be attached to the power supply connector in the second embodiment of the present invention;

FIG. 7 is a front view of the LED module attached to the power supply connector in the second embodiment of the present invention;

FIG. 8 is a top view of one example of an arrangement of the contact terminal provided in the power supply connector in the second embodiment of the present invention;

FIG. 9 shows in cross-section the LED module attached to the power supply connector in the second embodiment of the present invention;

FIG. 10 shows the power supply connector and the LED module which is to be attached to the power supply connector in the third embodiment of the present invention;

FIG. 11 is a perspective view of the LED module attached to the power supply connector which is attached to a part of the lamp body in the third embodiment of the present invention; and

FIG. 12 is a side view, partially in cross-section, of the LED module attached to the power supply connector which is attached to a part of the lamp body in the third embodiment of the present invention.

### DETAILED DESCRIPTION OF THE INVENTION

Best modes for implementing the vehicular lamp of the present invention will be described below with reference to the attached drawings.

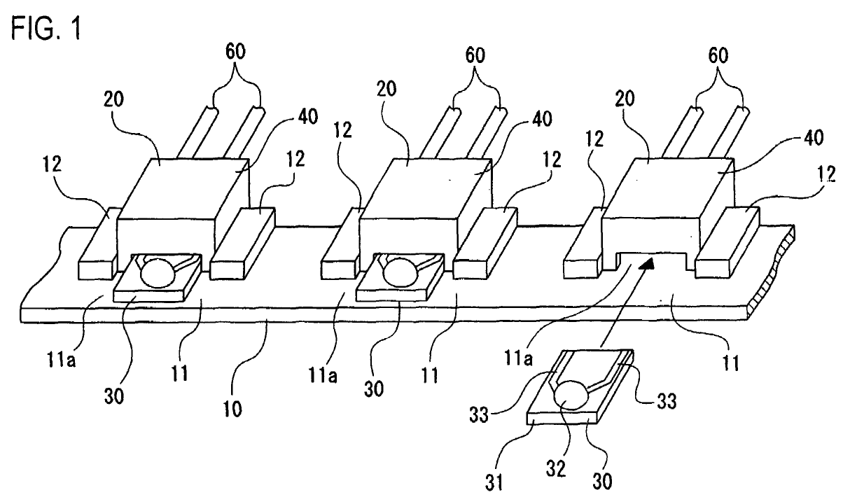

The first embodiment of the vehicular lamp of the present invention is shown in FIGS. 1 to 4.

As noted above, the object of the present invention is to reduce the cost and facilitate the design of a vehicular lamp by standardizing an LED module serving as a light source portion and a power supply connector to which the LED module is attached and by disposing a suitable number of LED modules for the shape and size of the vehicular lamp in optimum positions. Accordingly, there are no limitations to the shape and size of the lamp; and thus in the following, the description will be made only on a part in the interior of the vehicular lamp to which the LED module is attached and which is the main part of the present invention.

As seen from FIG. 1, a bracket 10 is formed in the interior of a vehicular lamp (not shown) either integrally with a lamp body or separately and attached to the lamp body (not shown) to form a part of the lamp body, and a plurality of power supply connectors 20 are attached to the bracket 10. In addition, a plurality of LED modules 30 (in the same number as the connectors) are attached respectively to the plurality of power supply connectors 20 in a detachable fashion.

With the structure as described above, by providing the power supply connectors 20 and LED modules 30 in numbers suited to the shape and size of a vehicular lamp and at optimum positions, it is possible to provide a vehicular lamp that has the required illuminance; and when a defect such as a breakage occurs in the LED module(s) 30 and/or power supply connector(s) 20, the defect can be easily corrected by replacing only the defective power supply connector(s) 20 and/or LED module(s) 30. Moreover, the power supply connector 20 and the LED module 30 can be standardized for universal use, and this can contribute to a cost reduction of the power supply connector 20 and LED module and an over all cost reduction of the vehicular lamp.

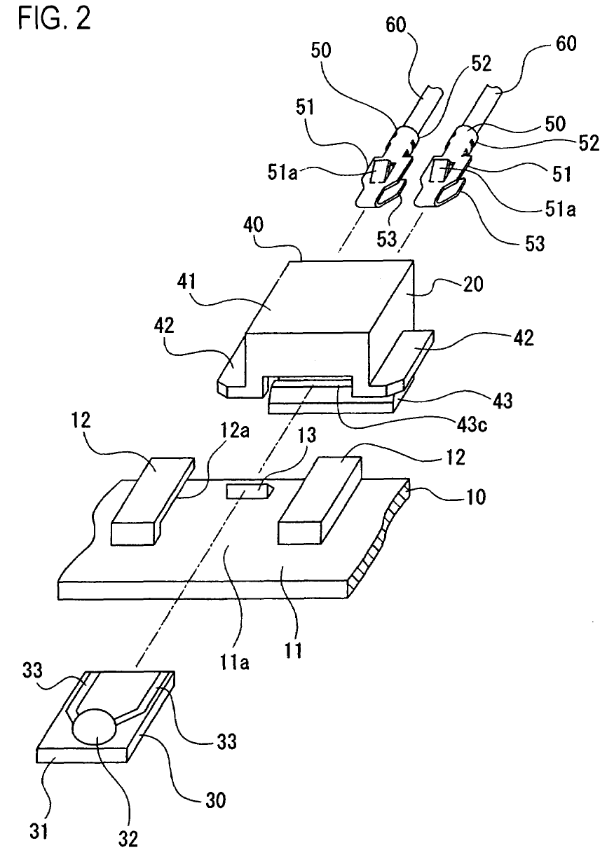

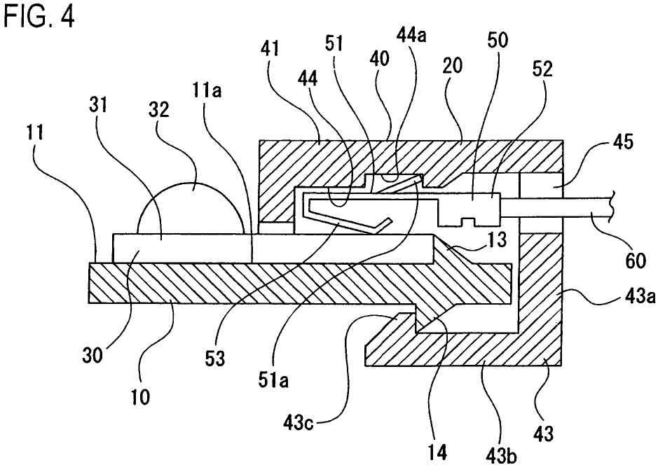

The bracket 10 is made from a material having good thermal conductivity and moldability, such as die cast aluminum, for example. The bracket 10 is comprised of a power supply connector mounting portion 11 formed in a substantially plate shape and support portions 12 extending in parallel in a front-back direction of the bracket 10 so as to project from one surface, for example the upper surface 11a, of the bracket 10. The support portions 12 are formed with insertion grooves 12a, as seen from FIG. 2, in the opposing side faces and open to the rear end. Furthermore, as seen from FIG. 4, the bracket 10 has a stopper 13 on the upper surface and an engagement pawl 14 on the lower surface. In other words, the stopper 13 projects from a position between the two support portions 12 on the upper surface 11a of the bracket 10, and the engagement pawl 14 projects from a position corresponding to the position between the two support portions 12 on the lower surface of the bracket 10.

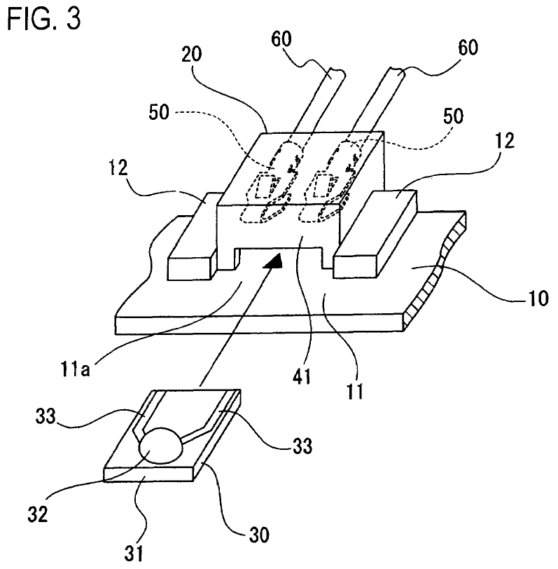

The power supply connector 20 is, as seen from FIGS. 2 and 3, comprised of a casing 40 made of an insulating material, for example, plastic, and a pair of contact terminals 50 supported by the casing 40.

The casing 40 of the power supply connector 20 includes an LED module accommodation portion 41, insertion guides 42 and an engagement tongue 43. The accommodation portion 41 is formed substantially in the shape of a gate when seen from the front and elongated in the front-back direction as seen from FIG. 4 in which the left side is the front. The insertion guides 42, as shown in FIG. 2, protrude sideways from the lower ends of the two sidewalls of the accommodation portion 41. The engagement tongue 43, as seen from FIG. 4, are provided under the accommodation portion 41 so as to serve as a fixing portion for positionally securing the casing 40 on the bracket 10. In this casing 40, the accommodation portion 41, insertion guides 42, and engagement tongue 43 are formed integrally.

The accommodation portion 41 is formed with parallel terminal receiving sections 44 on the lower surfaces of two side areas of its top wall, and as seen from FIG. 4, an engagement recessed portion 44a is formed in the intermediate portion of each one of the terminal receiving sections 44 in the front-back direction. The accommodation portion 41 is formed with back walls 45 on both sides of the rear end portion, and these back walls 45 are connected integrally to the two side portions of the rear end portion 43a of the engagement tongue 43. The engagement tongue 43 is comprised such that a rear end portion 43a, which is substantially vertical, and an elastic piece 43b, which protrudes frontward from the lower end of the rear end portion 43a, are formed continuously to make substantially an L shape when seen from the side, and an engagement pawl 43c projects upward from the upper surface of the front end of the elastic piece 43b.

The contact terminals 50 are made from a metal having good electrical conductivity and spring elasticity. As seen from FIG. 2, each one of the contact terminals 50 is formed so that a cord holding portion 52 is connected to the rear end of a flat-plate form main portion 51, and a contact piece 53 is provided at the tip end of the main portion 51. The contact piece 53 is bent downward and then backward. The main portion 51 of the contact terminal 50 is formed with a retaining piece 51a that is cut and then raised upward. The end portion of a power supply cord 60 is clamped by the cord holding portion 52 of the contact terminal 50, and the contact terminal 50 and the power supply cord 60 are thus electrically connected.

The contact terminals 50 are, as seen from FIG. 4, inserted into the terminal receiving sections 44 of the casing 40 of the power supply connector 20 from the back; and when contact terminals 50 are thus set in the casing 40, the retaining pieces 51a of the contact terminals 50 are engaged with the engagement recessed portions 44a formed inside the terminal receiving sections 44 of the casing 40 (FIG. 4 shows only one of the retaining pieces 51a and the engagement recessed portion 44a). As a result, the contact terminals 50 are disposed in the terminal receiving sections 44 of the casing 40 in a retained manner.

The thus formed power supply connector 20 is attached to the power supply connector attachment portion 11 of the bracket 10 from the back. More specifically, as seen from FIG. 2, the insertion guides 42 formed on both sidewalls of the casing 40 of the power supply connector 20 are inserted gradually into the insertion grooves 12a of the support portions 12 of the bracket 10 from the back. During this insertion process, the engagement tongue 43 of the power supply connector 40 is moved gradually forward (toward left in FIG. 4) so as to sandwich, as shown in FIG. 4, the bracket 10 between the engagement tongue 43 from below and the accommodation portion 41 from above. When the insertion guides 42 of the casing 40 of the power supply connector 20 are inserted up to the front end of the insertion grooves 12a of the support portions 12 of the bracket 10, the engagement pawl 43c at the tip end of the engagement tongue 43 of the casing 40 passes over the engagement pawl 14 of the lower surface of the bracket 10 and is positioned on the front side of the engagement pawl 14. As a result, the engagement pawl 14 of the bracket 10 and the engagement pawl 43c of the power supply connector 20 enter into a state of mutual engagement (see FIG. 4). With this mutual engagement, the power supply connector 20 is prevented from moving rearward (to the right in FIG. 4) from the power supply connector attachment portion 11 of the bracket 10, and thus, the power supply connector 20 is fixed to the bracket 10.

The LED module 30 is, as seen from FIG. 2, comprised of an LED circuit board 31 having a planar, rectangular flat-plate form and an LED 32 provided on the upper surface (LED carrying surface) of the LED circuit board 31. A pair of conduction portions 33 formed by, for example, printed conductors are provided on the upper surface of the LED circuit board 31 so as to be on both sides of the LED 32. The conduction portions 33 are connected respectively to a pair of power supply terminals, not shown in the drawings, of the LED 32.

The LED circuit board 31 of the LED module 30 is inserted into the accommodation portion 41 of the power supply connector 20 from the front. In this insertion process of the LED module 30, when, as seen from FIG. 4, the rear end of the LED circuit board 31 comes into contact with the stopper 13 of the bracket 10, insertion movement of the LED circuit board 31 into the accommodation portion 41 is stopped; and in this state, the contact pieces 53 of the contact terminals 50 of the power supply connector 20 respectively contact the conduction portions 33 of the LED module 30. As a result, power (electricity) is supplied to the LED 32 via the conduction portions 33, the contact terminals 50, and the power supply cords 60. In addition, the bottom surface of the LED circuit board 31 contacts the upper surface 11a of the power supply connector attachment portion 11 of the bracket 10; and as a result, heat generated upon illumination of the LED 32 is discharged quickly via the LED circuit board 31 and the bracket 10.

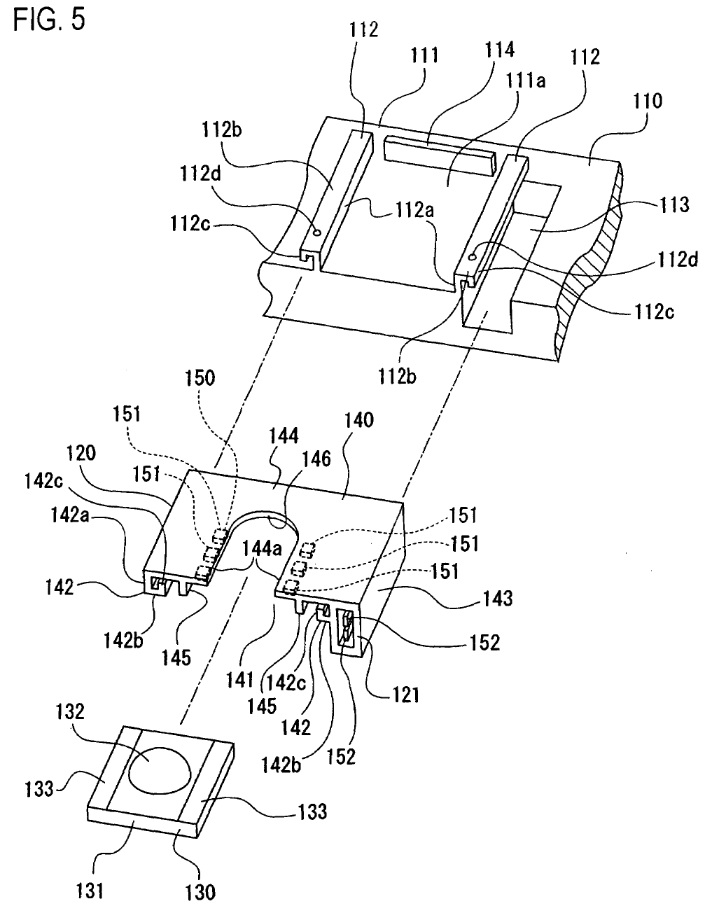

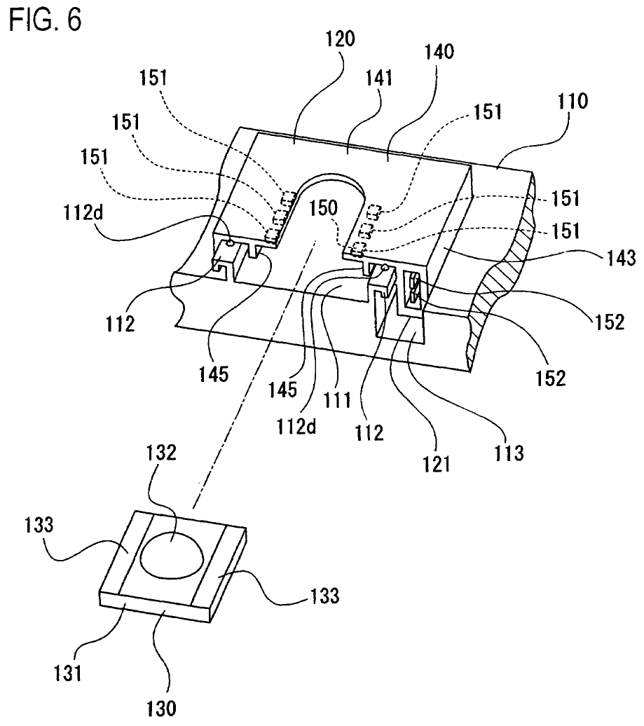

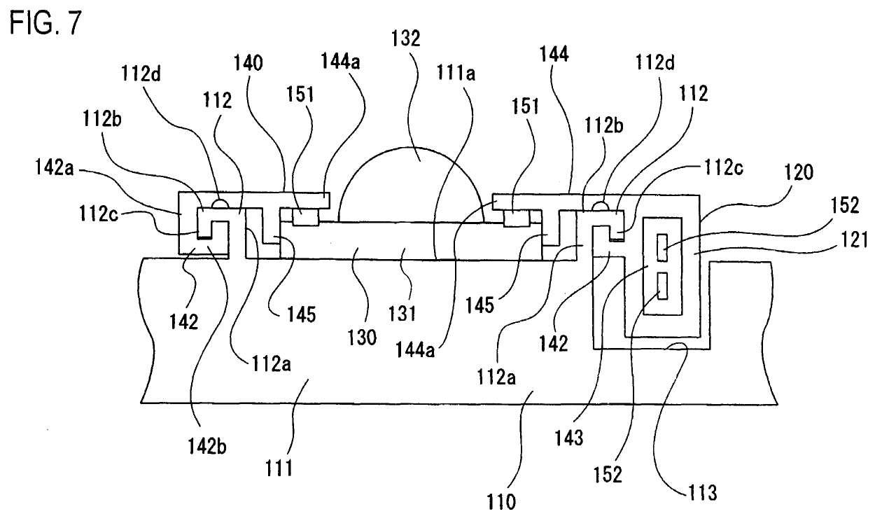

FIGS. 5 through 9 show the second embodiment of the vehicular lamp of the present invention. Likewise in the first embodiment, the description will be limited to the LED module attachment part of the interior of the vehicular lamp, which is the main part of the present invention.

A bracket 110, made integrally with a lamp body (not shown) or attached to a lamp body to form a part of the lamp body, is formed inside of a vehicular lamp, and a plurality of power supply connectors 120 (only one of which is shown) are attached to the bracket 110. A plurality of LED modules 130 (only one of which is shown) are attached respectively to the power supply connectors 120 in a detachable manner.

The bracket 110 is made from a material having good thermal conductivity and moldability, such as, for example, die cast aluminum. A pair of support portions 112 protrude from the upper surface 111a of the power supply connector attachment portions 111 (only one of which is shown) of the bracket 110 so that they extend in parallel in the front-back direction. The pair of support portions 112 are comprised of upright portions 112a standing upright from the upper surface of the bracket 110, upper surface portions 112b protruding in opposite directions to each other from the upper end of the upright portions 112a, and fall-prevention portions 112c protruding downward from the protruding end of the upper surface portions 112b, all of which being formed integrally. Stoppers 112d, in a shape of small hemispheres, are provided in positions near the front end of the upper surface of the upper surface portions 112b of the support portions 112.

The bracket 110 is, as seen from FIG. 5, further provided with reception grooves 113 and an impinging projection 114 for each one of the power supply connector attachment portions 111. The reception groove 113 is formed on the outside of one of the support portions 112 of the power supply connector attachment portion 111, for example, the support portion 112 on the right side from the front, or in other words in a position on the opposite side of the other support portion 112, so as to extend in the front-back direction. The impinging projection 114 projects from the upper surface 111a of the power supply connector attachment portion 111. The impinging projection 114 is provided near the rear end of the power supply connector attachment portion 111 and between the two support portions 112.

The power supply connector 120 is comprised of a casing 140 made from an insulating material, for example, plastic, and a pair of contact terminals 150 provided in the casing 140.

In the casing 140 of the power supply connector 120, engagement portions 142 serving to attach the power supply connector 120 to the bracket 110 are formed on two sides of an LED module accommodation portion 141 of the casing 140 into which the LED module 130 is inserted, and a connector compartment 143 is formed on the outside portion of one of the engagement portions 142. The accommodation portion 141 and the two engagement portions 142 share a common ceiling plate 144. The accommodation portion 141 is defined by the ceiling plate 144 and two partition walls 145, which protrude downward from the lower surface of the ceiling plate 144 and extend in parallel in the front-back direction. The ceiling plate 144 between the two partition walls 145 is formed with a U-shaped notched opening 146 that extends in the front-back direction of the ceiling plate 144 and is open at the front end. The ceiling plate 144 between the notched opening 146 and the partition walls 145 forms eave-shaped portions 144a.

Each of the engagement portions 142 is formed by a vertical outside wall portion 142a protruding downward from the ceiling plate 144 on the outside of the partition wall 145, a horizontal wall portion 142b protruding substantially horizontally from the lower end of the vertical outside wall portion 142a toward the partition wall 145, and an upright engagement piece 142c protruding upward from the tip end of the horizontal wall portion 142b, all of which are formed integrally.

The front end portion of the connector compartment 143 takes an angular tube form, and an upper surface thereof is positioned coplanar with the upper surface of the ceiling plate 144. The upper end portion of one side face of the connector compartment 143 is joined integrally to one of the vertical wall portions 142a (the right side outside wall portion 142a in FIG. 5) of the engagement portion 142. The accommodation portion 141 and engagement portions 142 are thus formed integrally.

The contact terminals 150 of the power supply connector 120 are made from a metal that has good electrical conductivity and spring elasticity. More specifically, each one of two contact terminals 150 is comprised of, as seen from FIG. 5, a plurality of contact pieces 151 (three along each one of the eave-shaped portions 144a in the shown embodiment) that contact conduction portions 133 of the LED module 130, a buried portion that is provided inside the casing 140 of the power supply connector 120 and is not shown in the drawing, and a terminal portion 152 that is disposed in the connector compartment 143, all of which being formed integrally.

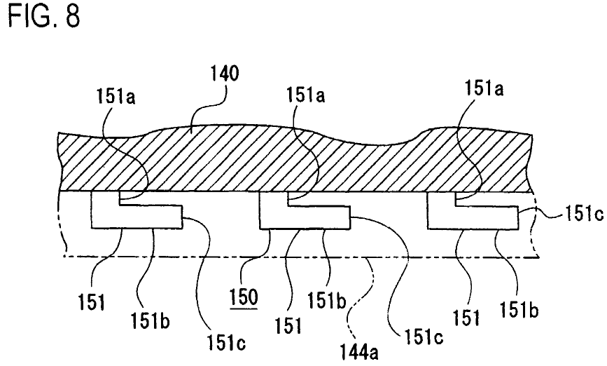

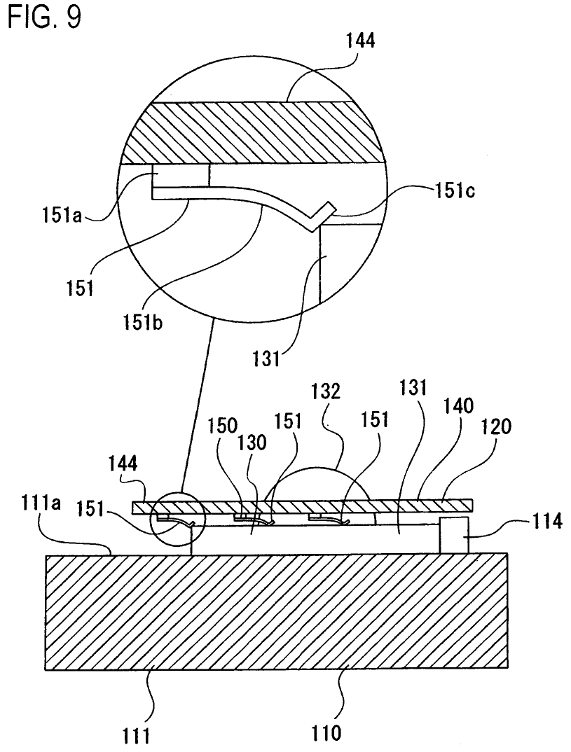

The contact terminals 150 are provided integrally with the casing 140 by burying the buried portions, not shown in the drawing, within the thickness of the casing 140 by means of insert molding performed during the injection molding of the casing 140, for example. The contact pieces 151 are, as seen from FIG. 9 which is a vertical cross sectional view, comprised of a base portion 151a protruding from the lower side of the eave-shaped portion 144a (see FIG. 8, a top partial view) from the side face of the partition wall 145, and a contact portion 151b protruding rearward from the tip end of the base portion 151a; and the rear end 151c of the contact portion 151b of the contact pieces 151 is bent into a substantially V shape when seen from the side. Further, two terminal portions 152 of the two contact terminals 150 are disposed inside the connector compartment 143, thus forming a female connector 121.

The engagement portions 142 of the power supply connector 120 as structured as described above are engaged with and mounted on the support portions 112 of the bracket 110 in the following manner: First, the power supply connector 120 is moved rearward (moved to the top side in FIG. 5) with respect to the power supply connector attachment portion 111 of the bracket 110 such that each one of the support portions 112 of the bracket 110 is inserted between the partition wall 145 and the engagement portion 142 of the power supply connector 120. As a result, the partition walls 145 of the power supply connector 120 abut against the opposing surfaces of the upright portions 112a of the support portions 112 of the bracket 110 such that the engagement piece 142c of each engagement portions 142 of the power supply connector 120 is positioned between the upright portion 112a and the fall-prevention portion 112c of the support portions 112. In this state, the engagement portions 142 of the power supply connector 120 are engaged with the support portions 112 of the bracket 110; and the connector compartment 143 or the female connector 121 of the power supply connector 120 is received in the reception groove 113 of the bracket 110. When the front ends of the engagement portions 142 of the power supply connector 120 pass over the stoppers 112d formed on the support portions 112 of the bracket 110, the front ends of the engagement portions 142 (the lower ends of the front end surface of the ceiling plate 144 in this part) engages with the stoppers 112d of the bracket 110, and the forward movement of the power supply connector 120 is stopped. As a result, the power supply connector 120 is attached to a predetermined position on the bracket 110.

The LED module 130 is comprised of an LED circuit board 131 of a planar, substantially rectangular form, an LED 132 provided on the upper surface (LED carrying surface) of the LED circuit board 131. The LED module 130 further includes a pair of conduction portions 133 formed at two side portions of the upper surface of the LED circuit board 131 (thus being on both sides of the LED 132) and electrically connected to the LED 132.

The LED circuit board 131 of the thus structured LED module 130 is inserted between the accommodation portion 141 of the power supply connector 120 and the bracket 110 from the front. More specifically, the LED circuit board 131 is inserted into a horizontally elongated space which is surrounded by the ceiling plate 144 and two partition walls 145 of the power supply connector 120 and by the upper surface of the power supply connector attachment portion 111 of the bracket 110, until, as seen from FIG. 9, the rear end of the LED circuit board 131 comes into contact with the impinging projection 114 of the power supply connector attachment portion 111.

When the LED circuit board 131 (or the LED module 130) is thus set on the bracket 110, the contact pieces 151, as shown in FIG. 9, provided on the lower side of the left and right eave-shaped portions 144a of the casing 140 of the power supply connector 120 are in contact with the conduction portions 133 of the LED module 130 elastically (only one of the contact pieces 151 is shown in FIG. 9); and as a result, the LED 132 on the LED circuit board 131 enters a state of electrical connection with the terminal portions 152 located in the female connector 121. Then, when a male-form connector (not shown) which is attached to the tip end of a power supply cord (not shown) and connected to a power source (not shown), is inserted into, and thereby connected to, the female connector 121 of the power supply connector 120, electric power is supplied to the LED 132. Furthermore as seen from the circled illustration of FIG. 9, the tip end portion 151 c of the contact piece 151 furthest to the front side of the contact pieces 151 enters into a state of engagement with the front end portion upper edge of the LED circuit board 131 (only one of the contact pieces 151 is shown in FIG. 9); as a result, the LED module 130 is prevented from moving forward (left side in FIG. 9). In addition, the bottom surface of the LED circuit board 131 is in contact with the upper surface of the power supply connector attachment portion 111 of the bracket 110, and thus the heat generated upon illumination of the LED 132 is discharged quickly via the LED circuit board 131 and bracket 110.

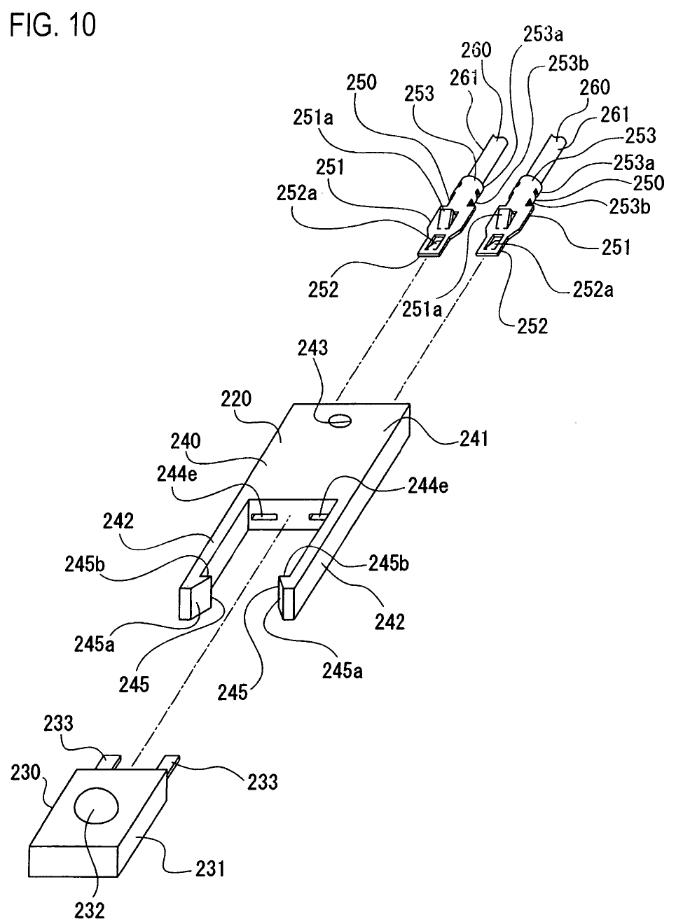

FIGS. 10 through 12 show the third embodiment of the vehicular lamp of the present invention.

A bracket 210, formed integrally with a lamp body (not shown) or attached to a lamp body to form a part of the lamp body, is disposed in the interior of a vehicular lamp (not shown); and a plurality of power supply connectors 220 (only one of which is shown) are attached to the bracket 210. LED modules 230 (only one of which is shown) are attached respectively to the plurality of power supply connectors 220 in a detachable manner.

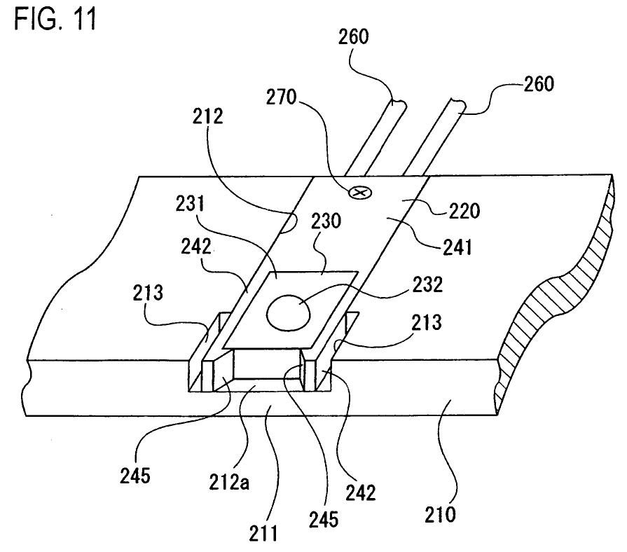

The bracket 210 is made from a material having good thermal conductivity and moldability, such as die cast aluminum, for example. As seen from FIG. 11, a groove-shaped attachment recessed portion 212 extending in the front-back direction of the bracket 210 is formed in the power supply connector attachment portion 211 of the bracket 210, and two escape recessed sections 213 are respectively formed in two inner side faces of the front end portion of the attachment recessed portion 212.

The power supply connector 220 is, as seen from FIG. 10, comprised of a casing 240 made of an insulating material, for example, plastic, and a pair of contact terminals 250 attached to the casing 240.

The casing 240 of the power supply connector 220 is comprised of a connector main body 241 and a pair of engagement arms 242. The connector main body 241 of the casing attaches the casing 240 to the bracket 210 and holds the contact terminals 150 therein, and the engagement arms 242 is formed to protrude forward from two sides of the front end portion of the connector main body 241. The connector main body 241 and engagement arms 242 of the casing 240 of the power supply connector 220 are formed integrally. A space between the two engagement arms 242 serves as an accommodation portion into which an LED module 230 is inserted.

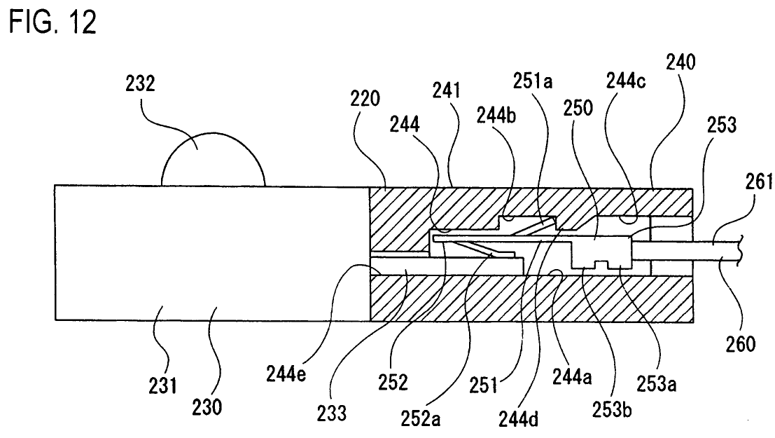

The connector main body 241 of the power supply connector 220 is formed with an attachment hole 243 penetrating the casing 240 in an up-down direction (vertically) at a substantially central portion thereof, and reception holes 244 (only one of which is shown in FIG. 12) penetrating the connector main body 241 in a front-back direction (horizontally) are formed in positions on either side of the attachment hole 243. As seen from FIG. 12, the inside lower surface 244a of each one of the reception hole 244 is formed substantially flat in the entire front-back direction, while the inside upper surface of the reception hole 244 is not flat and an engagement recessed portion 244b is formed in the central portion of the upper surface. In each reception hole 244, the inside upper surface of the rear end portion 244c is at a substantially identical height to the inside upper surface of the engagement recessed portion 244b, and an engagement protruding portion 244d is formed between the engagement recessed portion 244b and the inside upper surface of the rear end portion 244c. Furthermore, the inside upper surface of the front end portion 244e is formed lower than the other portion of the reception hole 244, so that the front end portion 244e makes a flat, contact receiving portion.

As seen from FIG. 10, the width of each one of the engagement arms 242 is made small, so that the engagement arms 242 have elasticity in the left-right (lateral or horizontal) directions. At the front ends of the engagement arms 242, engagement pawls 245 are formed so that they protrude from the opposing faces. The front surface 245a of each one of the engagement pawls 245 is inclined with respect to the length direction of the engagement arms 242, and the rear surface 245b of the engagement pawl 245 serves as an engagement surface.

Each of the contact terminals 250 is made from a material having good electrical conductivity and spring elasticity. Each contact terminal 250 comprises a central portion 251, a contact portion 252 and a cord connecting portion 253. The contact portion 252 is formed integrally and continuously at the front side of the central portion 251, and the cord connecting portion 253 is formed integrally and continuously to the rear side of the central portion 251. An engagement piece 25 la is formed in the central portion 251 of the contact terminals 250 in an upwardly punched-out fashion so that its tip end is oriented rearward, and an elastic contact piece 252a is formed in the contact portion 252 of the contact terminals 250 in a downwardly punched-out fashion so that its tip end is oriented rearward. Rear clamp pieces 253a and front clamp pieces 253b are formed in the cord connecting portion 253 of each contact terminal 250 so that they protrude inwardly.

To the contact terminals 250, power supply cords 260 are connected. More specifically, a core wire (not shown) is exposed at the tip end of each one of the power supply cords 260, which are connected to a power supply (not shown) at other ends, and brought into contact with the inside of each contact terminal 250 having good electrical conductivity. The cladding 261 of the power supply cord 260 is press-fitted to the cord connecting portion 253 of the contact terminals 250 by the rear clamp pieces 253a. The core wire of the power supply cord 260 is press-fitted to the cord connecting portion 253 of the contact terminal 250 by the front clamp pieces 253b. The respective power supply cords 260 and the contact terminals 250 are thus connected electrically and mechanically.

The power supply connector 220 is set in the attachment recessed portion 212 of the bracket 210; and with a screw 270 penetrating the attachment hole 243 from above into a screw hole (not shown), which is formed in the attachment recessed portion 212 of the bracket 210, the power supply connector 220 is fixed to the attachment recessed portion 212 of the bracket 210. As seen from FIG. 11, the substantially front half of each of the engagement arms 242 of the power supply connector 220 is positioned so as to face the escape recessed section 213 in the attachment recessed portion 212 of the bracket 210.

As shown in FIG. 12, the contact terminals 250, which are connected to the power supply cords 260 in the manner described above, are inserted into the reception holes 244 of the casing 240 of the power supply connector 220 from the back and held inside the reception holes 244. More specifically, as seen from FIG. 12, the engagement piece 251a of the central portion 251 of each one of the contact terminals 250 is positioned inside the engagement recessed portion 244b of the reception hole 244 of the casing 240, and the rear end of the engagement piece 251a of the contact terminal 250 is engaged with the front surface of the engagement protruding portion 244d of the casing 240, so that the contact terminal 250 is prevented from moving rearward to be out of the reception hole 244. In addition, the contact portion 252 of the power supply connector 220 is positioned directly on the rear side of the contact receiving portion 244e of the reception hole 244 of the casing 240.

The LED module 230 is, as seen from FIG. 10, comprised of an LED circuit board 231 of a substantially flat plate form, an LED 232 provided on the upper surface (LED carrying surface) of the LED circuit board 231, and two blade contacts 233 serving as conduction portions. The blade contacts 233 to project rearward from the rear end of the LED circuit board 231. The LED 232 and the blade contacts 233 are connected by connection conductors (not shown) which are provided on the surface of the LED circuit board 231 or inside the LED circuit board 231.

The thus structured LED module 230 is inserted gradually between the two engagement arms 242 (that make an accommodation portion for the LED module 230) of the power supply connector 220 from the blade contacts 233 side. The inclined surfaces 245a on the engagement pawls 245 of the engagement arms 242 of the power supply connector 220 are pressed by the two side corners on the front end of the LED circuit board 231, and the front half portions of the engagement arms 242 are bent outwardly into the escape recessed section 213 (see FIG. 11) of the bracket 210. Then, the blade contacts 233 of the LED module 230 are, as shown in FIG. 12, inserted into the contact receiving portions 244e of the reception holes 244 of the power supply connector 220, so that the elastic contact-pieces 252a of the contact terminals 250 elastically contact the upper surfaces of the blade contacts 233 of the LED module 230. As a result, electric power can be supplied to the LED 232 via the contact terminals 250 and the power supply cords 260.

Once the blade contacts 233 of the LED module 230 are inserted completely into the contact receiving portions 244e of the power supply connector 220, the front half portions of the engagement arms 242 of the power supply connectors 220 return to their original state; and, as seen from FIG. 11, the engagement surfaces 245b of the engagement pawls 245 engage with the two side portions on the front surface of the LED circuit board 231, thus preventing the LED module 230 from moving forward to be out of the power supply connector 220. Further, the bottom surface of the LED circuit board 231 contacts the upper surface 212a of the attachment recessed portion 212 of the bracket 210. Accordingly, heat generated upon illumination of the LED 232 is discharged quickly via the LED circuit board 231 and the bracket 210.

It should be noted that the shape and structure of the various parts described in each of the above embodiments are merely concrete examples employed upon implementation of the present invention, and the technical scope of the present invention is not to be interpreted in a limited manner by these examples.

1. A vehicular lamp comprising a plurality of power supply connectors attached to a lamp body, and a plurality of LED modules attached to the power supply connectors in a detachable manner, wherein
the LED module comprises an LED circuit board in a form of substantially flat plate, an LED provided on an LED carrying surface of the LED circuit board, and a pair of conduction portions provided on the LED circuit board and electrically connected to the LED,
the power supply connector comprises an attachment portion attached to the lamp body, a accomodation portion into which the LED circuit board of the LED module is inserted in a direction parallel to the LED carrying surface when the power supply connector is attached to the lamp body, and a pair of contact terminals; and
when the LED circuit board of the LED module is inserted into the accommodation portion of the power supply connector such that the LED module is attached to the power supply connector, the pair of contact terminals of said power supply connector is in contact with the pair of conduction portions of said LED module, respectively.

2. The vehicular lamp according to claim 1, wherein the contact terminals of said power supply connector engage with the LED circuit board inserted into the accommodation portion of said power supply connector, thus preventing said LED circuit board from being separated from the accommodation portion.

3. The vehicular lamp according to claim 1, wherein when said LED module is attached to the power supply connector, a surface which is on an opposite side from the LED carrying surface of said LED circuit board is in contact with a part of the lamp body.

4. The vehicular lamp according to claim 2, wherein when said LED module is attached to the power supply connector, a surface which is on an opposite side from the LED carrying surface of said LED circuit board is in contact with a part of the lamp body.
